(19) United States
(12) Patent Application Publication
(10) Pub. No.: US 2009/0207550 A1
(43) Pub. Date: Aug. 20, 2009

(54) ELECTRICAL FEEDTHROUGH COMPONENT AND METHOD FOR ITS PRODUCTION

(75) Inventors: Thomas Feichtinger, Graz (AT); Markus Ortner, Graz (AT)

Correspondence Address: FISH & RICHARDSON PC, P.O. BOX 1022, MINNEAPOLIS, MN, 55440-1022, US

(73) Assignee: EPCOS AG, Munich (DE)

(21) Appl. No.: 11/914,063

(22) PCT Filed: May 11, 2006
(86) PCT No.: PCT/DE2006/000817

§ 371 Date: May 29, 2008

(30) Foreign Application Priority Data
May 12, 2005 (DE) 102005022142.4

(51) Int. Cl. H01G 4/35; H01G 4/005; H01G 4/30

(52) U.S. Cl. 361/301.4; 361/302; 361/303; 29/25.42

(57) ABSTRACT

An electrical component that is surface mountable includes a base body having first inner electrodes and second inner electrodes. A first outer electrode extends along the base body in a first direction, and a through connection extends along the base body in a second direction that is different from the first direction. The first inner electrodes are electrically connected to the first outer electrode. The second inner electrodes are electrically interconnected via the through connection.

### TECHNICAL FIELD

An electrical feedthrough component is described.

### BACKGROUND

A ceramic, multiple-layer capacitor is known from the publication DE 101 36 545 A1. Another ceramic component and also a method for its production are known from the publication DE 101 32 798 C1.

### SUMMARY

Described herein is an electrical feedthrough component that has a high capacitance with a low surface area, and a method for the manufacture thereof.

An electrical feedthrough component with a base body is described, in which first inner electrodes and second inner electrodes are arranged, wherein the first inner electrodes are connected to each other via a first outer electrode that extends in a peripheral direction of the base body, and wherein second inner electrodes are connected to each other in a conductive way via a through connection extending in the axial direction of the base body. The feedthrough component is for surface mounting.

The component can achieve noise suppression in a signal line over a wide frequency range. The component may be a feedthrough filter for suppressing noise in signal lines of high-frequency circuits, for example, as a broadband filter for IT applications. The component can be integrated, e.g., in a plug or a power supply.

The component has a high capacitance, low parasitic inductance, high current, especially in the feedthrough direction, and small dimensions. High-frequency noise signals are damped with high insertion loss. The high insertion loss at high frequencies is traceable back to the low value of the parasitic inductance.

The through connection is conductively connected to second outer electrodes, which are arranged at least partially on opposing end surfaces of the base body arranged perpendicular to the axial direction.

Alternately arranged first and second inner electrodes form an electrode stack. The first and second inner electrodes are insulated electrically from each other. The first inner electrodes are arranged perpendicular to the first outer electrode. The second inner electrodes are arranged parallel to the second outer electrode.

The second inner electrodes are connected to each other via the through connection. In contrast, the edges of the second inner electrodes are spaced apart from the circumferential surface of the base body.

The edges of the first inner electrodes reach up to the circumferential surface of the base body. A recess for realizing the through connection is provided in each of the first inner electrodes. The recess in the first internal electrode may be an opening or a hole.

The through connection is arranged essentially parallel to the surface area of the base body. The through connection may be concealed in the base body. The through connection can be constructed as a solid rod. Alternatively, the through connection can be constructed in the base body as an opening with metallized walls.

The first outer electrode is arranged on the circumferential surface of the base body and may surround the base body on all sides.

In an embodiment, the base body is cubical. The surface of the base body, which is provided for connection to the circuit board, is designated as its bottom side or the main surface. Two opposing side surfaces of the base body, on which the second outer electrodes are arranged, are designated as its end sides. The end sides can also be designated as a base surface and a top surface of the base body. The remaining four surfaces form a circumferential surface of the base body.

A symmetrical construction of the base body is advantageous. The feedthrough component may have a mirror-symmetric construction relative to a plane passing through the center of the base body and arranged perpendicular to the axis of the through connection.

The feedthrough component can have a mirror-symmetric construction relative to a plane which is arranged parallel to the base surface and perpendicular to the end surfaces of the base body, and in which the axis of the through connection lies.

The feedthrough component can have a mirror-symmetric construction relative to a plane which is arranged perpendicular to the base surface and perpendicular to the end surfaces of the base body, and in which the axis of the through connection lies.

An “active” area of the base body is designated as a functional unit, which is formed by a stack of dielectric layers and first and second inner electrodes arranged between them. The first and second inner electrodes are here arranged in a stack alternating one above the other. A functional unit may be used as a capacitor or a varistor. In one variant, the feedthrough component can have more than just one functional unit.

The component may have two second outer electrodes, which are arranged at least partially on opposite end surfaces of the base body, for each functional unit. In one variant, the through connection is guided through the base body and connects the two second outer electrodes to each other.

In another variant, the ends of the through connection are spaced apart from the second outer electrode. In this case, the through connection is connected on its two ends to at least one third internal electrode whose edges contact a part of the second outer electrode arranged on the circumferential surface of the base body. This results in a good connection of the through connection and the second inner electrode to the second outer electrode. Several third inner electrodes may be connected to each end of the through connection.

In one variant, several functional units, which are each constructed essentially like the functional unit described above, are arranged in one base body. Here, different stacks of first and second inner electrodes are each associated with a separate signal path.

At least one separate second outer electrode, e.g., two separate second outer electrodes, are associated with the second inner electrodes. The first inner electrodes of all of the stacks may be connected to at least one common first outer electrode.

Other through connections can be arranged, in the base body each of which connects at least two of the first inner electrodes to each other electrically. These through connections may be arranged between two adjacent stacks of inner electrodes.

The first outer electrode may be a ground connection and the second outer electrode may be a signal connection.

The feedthrough component may be a chip for surface mounting on an external circuit board, i.e., as a component with SMD contacts (SMD=Surface Mounted Device). An SMD contact, e.g., at least one part of the first outer electrode, can be arranged on the bottom side of the base body facing the circuit board.

However, an SMD contact could also be arranged on a side surface of the base body. For example, the second outer electrode provided as an SMD contact is arranged at least partially on an end side of the base body. The second outer electrode can completely top the end side of the base body or only part of this surface. Here the end surfaces of the base body may lack the first outer electrode.

The second outer electrode could project past the edges, e.g., past the lower and/or the upper edge of the end side associated with it. It is advantageous for a part of the second outer electrode to be arranged on the bottom side of the base body.

In one variant, at least one area of the circumferential surface of the base body is not covered by the first outer electrode. The circumferential surface of the base body may be divided in the axial direction into two peripheral or belt-shaped edge regions and an also peripheral or belt-shaped center region between these edge regions. The center region of the base body is covered by the outer electrode, wherein the edge regions are not covered by the first outer electrode.

The feedthrough component with the through connection may be produced in a multiple-layer method.

This method comprises the following steps:

A) Edge regions of the base body are constructed each with a first opening filled with a conductive paste,

B) An intermediate region of the base body is constructed with first and second inner electrodes arranged in this intermediate region and with a second opening filled with a conductive paste that conductively connects the second inner electrodes to each other and that is guided through a recess provided in the first inner electrodes, wherein the first inner electrodes are constructed so that their edges are exposed,

C) The intermediate region is oriented between the edge regions such that the first openings and the second opening are arranged along one axis and form a through connection,

D) A first outer electrode contacting the edges of the first inner electrodes is created at least on the surface of the intermediate region,

E) Second outer electrodes conductively connected to the through connection are created on the end sides of the base body.

The steps A) and B) can be performed simultaneously. The steps D) and E) can be performed in one processing step.

The base body may be sintered before steps D) and E). The first outer electrode and the second outer electrodes may each be applied with a conductive paste onto a sintered body and fired.

Each of the mentioned regions of the base body may be generated in a multiple-layer process.

In order to form a part of the through connection, a continuous opening filled with a metallic paste is constructed in each edge region so that it passes through the respective edge region and appears at a surface of the edge region provided as an end surface of the base body. Later, for forming a second outer electrode on this surface e.g., only after sintering of the base body—an electrically conductive paste, which monolithically joins to the end side of the through connection when the outer electrode is fired, is deposited at least in the region of the exposed end of this opening.

In order to create an edge region, e.g., ceramic layers with continuous holes, which are formed in these layers and are filled by an electrically conductive paste, are stacked one above the other so that their holes are arranged one above the other along an axis—the longitudinal axis of the future through connection—and pressed together. These holes each form a part of the through connection. The ceramic layers may be constructed independently of each other, then stacked one above the other and pressed together so that they connect to each other and reach a designated thickness.

In order to create the intermediate region, ceramic layers are also created with continuous holes formed in these layers and filled by a conductive paste. Conductive surfaces are created between the ceramic layers, e.g., through screen printing, optionally with the use of masks, for forming first and second inner electrodes.

The terminally situated layers of the intermediate region may be ceramic layers. The ceramic layers are arranged one above the other so that one hole is arranged above the other. The stack formed in this way is pressed together and arranged between the edge regions. All of the regions are pressed together again, which forms the base body. By pressing the edge region or the intermediate region of the base body, parts of the through connection formed by filled holes are connected to each other, or an opening passing through the base body and filled with the conductive paste is formed by pressing together all of the base body regions.

The base body is sintered. In this way, in one variant the conductive paste located in the continuous opening is converted into a solid through connection.

In one variant, the conductive paste can be partially removed from the continuous opening before sintering of the base body, e.g., through suction. The inner walls of the opening, however, remain covered with the conductive paste, so that a hollow feedthrough with metallized walls is produced when the base body is sintered.

Instead of using the steps A) to C) on the layer series of the first edge region, it is possible in one variant of the method to create the layer sequence of the intermediate region, and on this series create the layer series of the second edge region.

In one variant, the edge regions are each constructed with at least one third internal electrode whose edges each intersect the surface of the edge region corresponding to the circumferential surface of the base body. A part of the through connection is formed in a part of the edge region facing towards the intermediate region, as described above. For several third inner electrodes, a via hole is constructed in the ceramic layers arranged in-between them in order to form another part of the through connection.

In order to form second outer electrodes, in a later processing step a metallic paste is deposited partially on the circumferential surface of the base body, such that it covers the edges of the one or more third inner electrodes. In firing the metallic paste, the second outer electrode is formed, which is monolithically joined to the one or more third internal electrode(s).

Ceramic, e.g., is suitable as the material for the dielectric layers. In one variant, the capacitor ceramic can be, for example, COG, X7R, Z5U, Y5V, HQM, or any other capacitor ceramic. In another variant, the ceramic layers can be formed from varistor ceramic, which contains, e.g., ZnO—Bi, ZnO—Pr, SrTiO₃. A feedthrough component constructed as varistor ceramic has filter properties on the one hand, and on the other hand can be used as over-voltage protection, in particular as ESD protection.

The feedthrough component is distinguished by a high ampacity of, e.g., more than 1 A. In one variant, the ampacity equals at least 2 A.

The feedthrough component will now be explained with reference to schematic figures that are not true to scale.

### DESCRIPTION OF THE DRAWINGS

FIG. 1A, the feedthrough component according to a first embodiment in a perspective view from above;

FIG. 1B, the base body of the feedthrough component according to FIG. 1A;

FIGS. 2A and 2B, the sections CC and BB through the feedthrough component according to FIG. 1A;

FIG. 2C, the section AA through the feedthrough component according to FIG. 1A (first variant for connecting second inner electrodes to second outer electrodes);

FIG. 3, the section AA through the feedthrough components according to FIG. 1A (second variant for connecting second inner electrodes to second outer electrodes);

FIG. 4A, the variant of the feedthrough component with several independent functional units in a perspective view from above;

FIG. 4B, the base body of the feedthrough component according to FIG. 4A;

FIGS. 5A and 5B, the sections AA and BB through the feedthrough component according to FIG. 4A;

FIG. 5C, the section CC through the feedthrough component according to FIG. 4A (first variant, in which the terminally situated first inner electrodes are connected to each other electrically by additional through connections);

FIG. 6, the section CC through the feedthrough component according to FIG. 4A (second variant, in which all of the first inner electrodes are connected to each other electrically by additional through connections).

### DETAILED DESCRIPTION

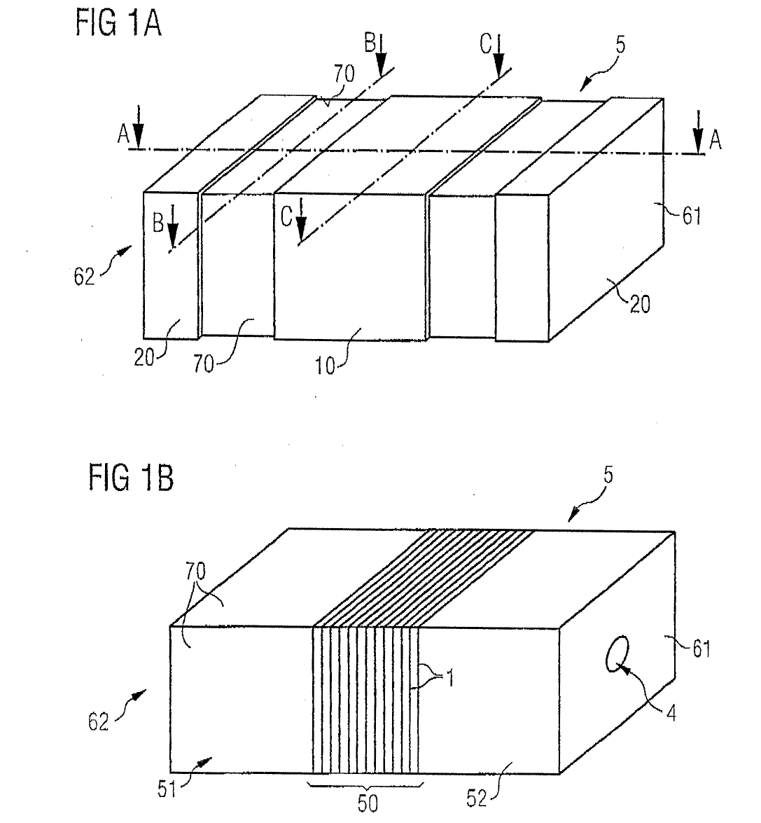

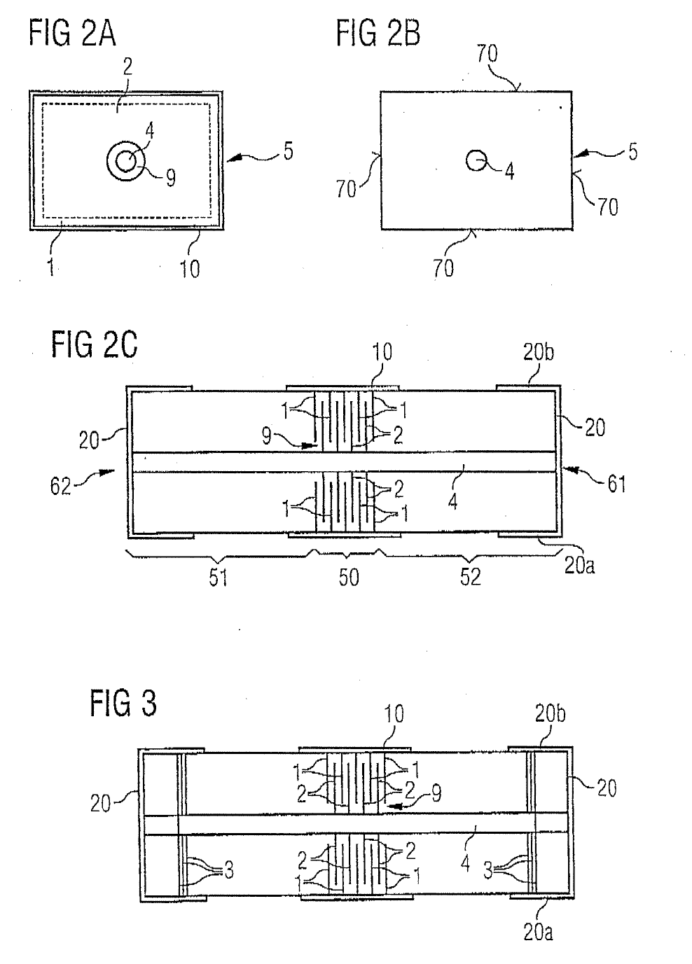

FIG. 1A shows a perspective view of a first construction of the feedthrough component with a functional unit integrated in a cuboid-shaped base body 5. The functional unit, which is also designated as an active region of the component, is formed by a stack of dielectric layers and first and second inner electrodes 1, 2 arranged between them. The first and second inner electrodes are here arranged in the stack alternately one above the other—in FIG. 2C one next to the other.

FIG. 1B shows the corresponding view of the base body 5 before the deposition of the outer electrodes 10, 20. Different cross sections of this component are shown in FIGS. 2A, 2B, and 2C. A variant of the connection of the second inner electrodes to the second outer electrode is presented in FIG. 3.

The base body 5 is divided into two “passive” edge regions 51, 52 and an “active” region—the intermediate region 50—arranged between these edge regions. The intermediate region 50 forms the functional unit of the component.

All of the first inner electrodes are connected to a first electrical potential. All of the second inner electrodes are connected to a second electrical potential, such as a reference potential, and are isolated electrically from the first inner electrodes.

The first inner electrodes 1 each represent a conductive surface in which a recess 9, constructed as a hole for example, is provided for realizing a via hole 4. The first inner electrodes 1 are concealed in the base body interior up to their edges. The edges of the first inner electrodes 1 are exposed on the surface or circumferential surface of the base body. A belt-shaped first outer electrode 10, which contacts the edges of the first inner electrodes 1 on all sides, is arranged on the circumferential surface 70 of the base body 5. The first outer electrode 10 may be connected to ground, and is used as shielding for the functional unit.

The second inner electrodes 2 are completely concealed in the base body interior and are spaced apart from the first outer electrode 10 (FIG. 2A). The second inner electrodes 2 are connected to each other electrically by the through connection 4. They are further connected electrically, by an electrical connection that comprises the through connection 4, to two second outer electrodes 20.

On both end sides 61, 62 of the base body 5 there is a second outer electrode 20 that completely covers the corresponding end side. The outer electrode 20 extends past the edges of the end surface 61 or 62, so that parts of these electrodes are arranged on all sides of the circumferential surface 70 of the base body.

The through connection 4 is completely concealed in the interior of the base body. In one variant, the through connection 4 can be constructed as a solid rod.

Alternatively, the through connection 4 can be constructed as a hollow tube, e.g., a continuous opening with metallized internal walls. In one variant, the through connection 4 also passes through the outer electrodes, so that the outer electrodes each have one opening. An electrical conductor, e.g., a wire, can be guided through a thus-constructed through connection from the outside. The electrical conductor may be solidly joined, e.g., soldered, at least at the ends to the through connection. However, it is also possible that a through connection constructed as a hollow tube is closed off at the ends by outer electrodes.

The feedthrough component may be arranged in a signal line, wherein the through connection 4 forms a part of the signal line and the functional unit forms a capacitor or a varistor that is arranged between the signal line and ground.

Shown in FIG. 2A is the cross section of the active region of the component, i.e., the intermediate region 50 of the base body 5 according to FIGS. 1A, 1B. The second internal electrode 2 connected to the through connection is indicated with a dashed line. The area of the first internal electrode 1 matches the cross section of the base body 5. The recess 9 of the first internal electrode 1 represents a round opening in the center region of this electrode, so that the first internal electrode 1 is spaced apart from the through connection 4.

Shown in FIG. 2B is the cross section of a first passive region of the component, i.e., the edge region 51 of the base body 5 according to FIGS. 1A, 1B. The second edge region 52 may be formed as mirror-symmetric to the first edge region 51. Although this is not shown in FIG. 1B, the respective edge region 51, 52 may be formed by dielectric layers stacked one above the other, wherein a part of the through connection 4 is formed in each of these layers.

In FIGS. 1A and 2C it is shown that the second outer electrodes 20 of the component each have a cap-shaped construction, wherein a part 20a of the outer electrode 20 is arranged on the bottom side, and its other part 20b—provided mainly for reasons of symmetry—is arranged on the top side of the base body 5.

In a variant not shown here, parts 20a, 20b of the second outer electrode 20 projecting past the end side 61, 62 are eliminated because an outer electrode standing perpendicular to the connection surface of a circuit board is also suitable, in principle, as an SMD contact. In this case, the second outer electrode 20 is arranged completely on the end side.

In a first variant shown in FIG. 2C, the through connection 4 passes through the base body 5 so that its ends each intersect the end sides 61, 62 of the base body 5 or the second outer electrodes 20 arranged on this body. In this case, the electrical connection between the two second outer electrodes 20 comprises the through connection 4.

In a second variant shown in FIG. 3, the ends of the through connection 4 are spaced apart from the corresponding second outer electrode 20 in the horizontal direction by one or more dielectric layers. The ends of the through connection 4 are each connected electrically to three third inner electrodes 3. A dielectric layer is arranged between every two adjacent third inner electrodes 3.

The third inner electrodes 3 each represent a continuous conductive surface that is concealed in the base body interior up to its edges. The edges of the third inner electrodes 3 are exposed on the circumferential surface of the base body and may form a contact on all sides by the parts 20a, 20b of the second outer electrode 20 arranged on the circumferential surface 70 of the base body 5.

The through connection 4 passes through all of the third inner electrodes 3 up to the last third internal electrode 3, which meets the end of the through connection 4. In this case, the electrical connection between the second inner electrodes 2 and the second outer electrode 20 is first formed by the through connection 4, and second by the third inner electrodes 3 connected in parallel. This type of electrical connection is distinguished by low losses at the joint to the second outer electrodes 20.

According to the embodiment only one third internal electrode, two, or more than three third inner electrodes can be used instead of three third inner electrodes 3 for connecting the through connection 4 to the parts 20a, 20b of the second outer electrode 20 arranged on the circumferential surface 70.

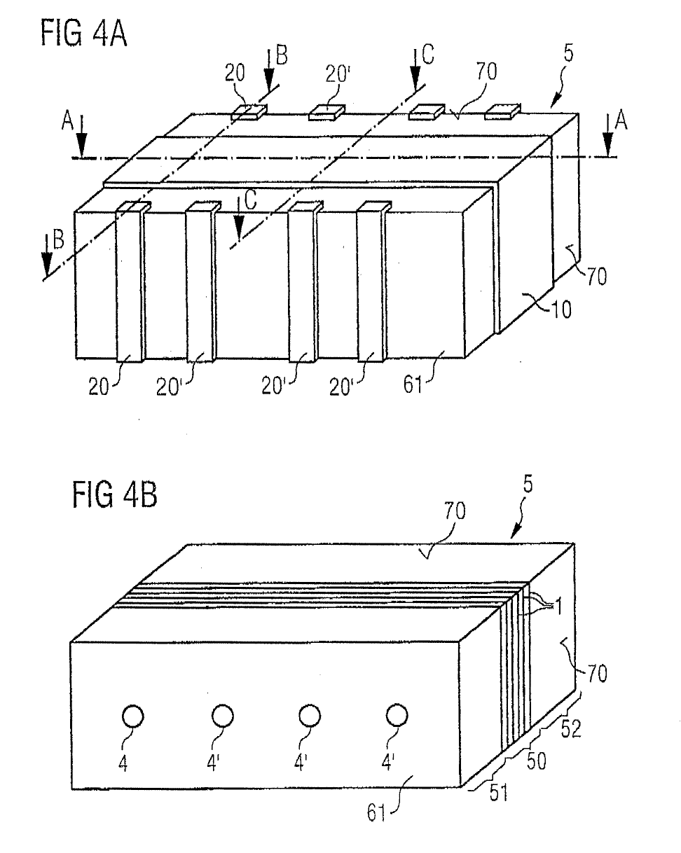

FIG. 4A shows a perspective view of a second design of the feedthrough component with several functional units integrated into a base body 5. FIG. 4B shows the corresponding view of the base body 5 before the deposition of the outer electrodes 10, 20, 20′.

The first end side 61 (base surface) of the base body 5 is located in FIGS. 1A and 1B on the right and its second end side 62 (top surface) is located on the left of the viewer. In FIGS. 4A and 4B, the front end side 61 (base surface) faces towards the viewer and the rear end side 62 (top surface) faces away from the viewer.

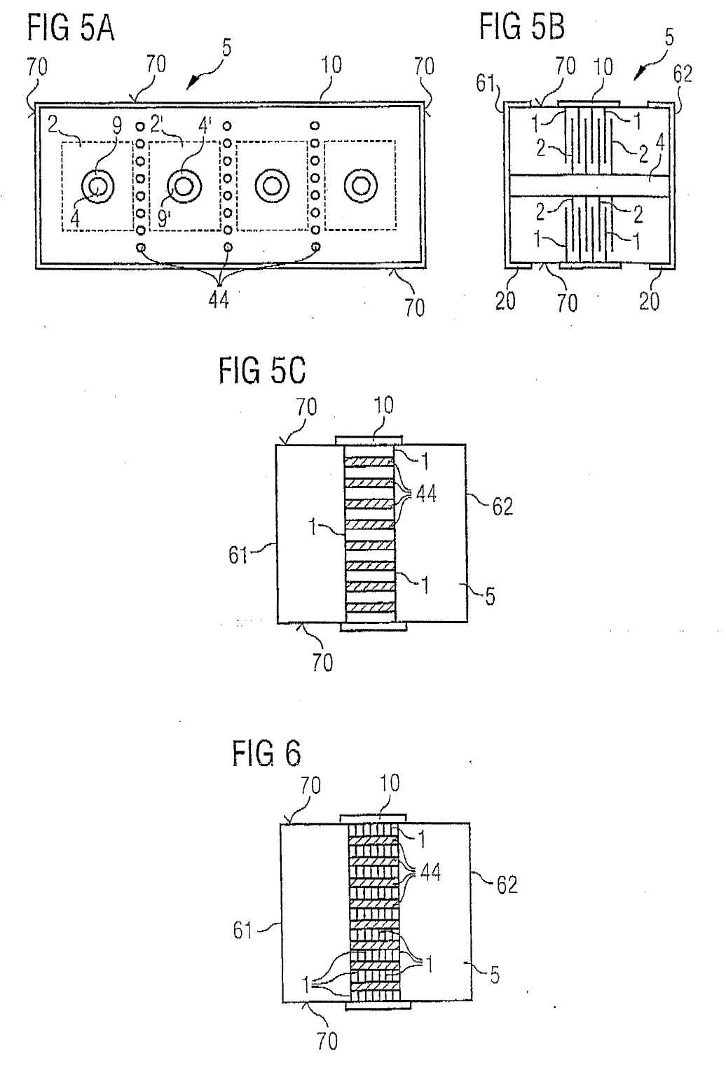

Different cross sections of this component are shown in FIGS. 5A, 5B, and 5C. One variant is presented in FIG. 6.

The functional units are each formed by a stack of dielectric layers and first and second inner electrodes 1, 2 or 1, 2′ arranged between them. The first and the second inner electrodes of a stack are arranged alternately one above the other—in FIG. 5B one next to the other.

The feedthrough component according to the second embodiment comprises, as a whole, four functional units, which may all be constructed identically or like the functional unit already explained in FIGS. 1A to 3. Each functional unit is arranged in a separate signal path for suppressing noise. A pair of second outer electrodes is associated with each functional unit. Two second outer electrodes 20 are associated with the first functional unit and two additional second outer electrodes 20′ are associated with each other functional unit.

All of the functional units are connected to a common first outer electrode 10. At least one of the first inner electrodes 1 may be constructed so that it is continuous up to the recesses 9, 9′ and connects all of the stacks to each other. In FIG. 5A, all of the first inner electrodes 1 are constructed so that all of their edges are exposed at the circumferential surface 70 of the base body and contact the first outer electrode 10 on all sides.

The cross section shown in FIG. 5B through the first stack coincides in principle with the cross section of the component according to the first embodiment shown in FIG. 2C except for the scaling of the base body 5.

1. An electrical component that is surface mountable, the electrical component comprising:
a base body comprising:
first inner electrodes; and
second inner electrodes;
a first outer electrode that extends along the base body in a first direction; and
a through connection that extends along the base body in a second direction that is different from the first direction;
wherein the first inner electrodes are electrically connected to the first outer electrode; and
wherein the second inner electrodes are electrically interconnected via the through connection.

2. The electrical component of claim 1, further comprising:
second outer electrodes electrically connected to the through connection.

3. The electrical component of claim 2, wherein the second outer electrodes are at least partially on end surfaces of the base body that are opposite each other and that are perpendicular to the second direction.

4. The electrical component of claim 2, wherein the through connection is through the base body and connects two second outer electrodes.

5. The electrical component of claim 2, further comprising:
at least one third internal electrode in the base body;
wherein the through connection comprises at least one end that is electrically connected to a part of one of the second outer electrodes via the at least one third internal electrode, the part of one of the second outer electrode being on an outer surface of the base body.

6. The electrical component of claim 1, wherein the first outer electrode is along a circumference of the base body and, in a cross-section, is perpendicular to the second direction.

7. The electrical component of claim 6, wherein at least one region of a surface of the base body is not covered by the first outer electrode.

8. The electrical component of claim 7, wherein the surface of the base body, in the second direction, comprises edge regions and a center region between the edge regions;
wherein the first outer electrode is in the center region; and
wherein the edge regions are not covered by the first outer electrode.

9. The electrical component of claim 1, further comprising:
a recess in each of the first inner electrodes, the through connection being through each recess.

10. The electrical component of claim 1, wherein the through connection is inside the base body.

11. The electrical component of claim 9, wherein each recess is an opening.

12. The electrical component of claim 1, wherein the base body is cubical in shape.

13. The electrical component of claim 1, wherein the through connection has comprises at least one section that is a solid rod.

14. The electrical component of claim 1, wherein the through connection comprises at least one section in the base body that comprises an opening and metallized walls.

15. The electrical component of claim 2, wherein each of the second outer electrodes projects at least past an edge between an end surface and a base surface of the base body.

16. The electrical component of claim 1, wherein first inner electrodes and second inner electrodes are arranged alternately within the base body and comprise a first electrode stack.

17. The electrical component of claim 16, further comprising:
at least one additional electrode stack in the base body, the at least one additional electrode stack having a construction like a construction of the first electrode stack.

18. The electrical component of claim 17, wherein each electrode stack comprises separate second inner electrodes and separate second outer electrodes.

19. The electrical component of claim 18, wherein first inner electrodes of different electrode stacks are electrically connected to at least one common first outer electrode.

20. The electrical component of claim 1, which is symmetric relative to a plane passing through a center of the base body and perpendicular to the second direction.

21. The electrical component of claim 1, which is symmetric relative to a plane parallel to a base surface of the base body, perpendicular to the end surfaces of the base body, and in the second direction.

22. The electrical component of claim 1, which is symmetric relative to a plane perpendicular to a base surface of the base body, and perpendicular to end surfaces of the base body, the second direction being within the plane.

23. The electrical component of claim 1, further comprising:
additional through connections that each electrically interconnect at least two first inner electrodes.

24. The electrical component of claim 23, wherein each of the additional through connections is between two electrode stacks.

25. The electrical component of claim 1 having a current capacity that exceeds 1 ampere.

26. The electrical component of claim 1, wherein the base body comprises varistor ceramic.

27. A method of producing an electrical component comprising a base body, the method comprising:
forming at least three parts of the base body, each of the at least three parts comprising a through connection; and
assembling the three parts so that respective through connections of each of the three parts meet.

28. The method of claim 27, wherein forming the at least three parts comprises forming edge regions of the at least three parts of the base body, each of the edge regions comprising a first opening comprising an electrically conductive paste;
wherein one of the at least three parts comprises an intermediate region comprising first inner electrodes and second inner electrodes and having a second opening, the second opening comprising an electrically conductive paste that electrically interconnects the second inner electrodes, wherein the first inner electrodes comprise edges that are at least partially exposed; and
wherein assembling the three parts comprises arranging the intermediate region is between the edge regions such that first openings of the edge regions and the second opening align to form a common through connection.

29. The method of claim 28, wherein assembling the three parts comprises:
including, on a surface of the intermediate region, a first outer electrode to electrically connect to the first inner electrodes; and
including, on end surfaces of the base body, second outer electrodes to electrically connect to the common through connection.

30. The method of claim 29, wherein forming the at least three parts comprises:
forming a continuous openings containing electrically conductive paste in ceramic layers of the edge regions of the base body and intermediate region; and
arranging successive ceramic layers one above the other such that continuous openings of the successive ceramic layers align to form the first and second openings.

31. The method of claim 30, further comprising:
removing electrically conductive paste from the first openings and the second opening to form the common through connection, the common through connection comprising inner walls of first and second openings, the inner walls comprising electrically conductive paste that remains after removing.
